(19) United States
(12) Patent Application Publication
(10) Pub. No.: US 2013/0340035 A1
(43) Pub. Date: Dec. 19, 2013

(54) PERFORMING A CHANGE PROCESS BASED ON A POLICY

(71) Applicants: Roie Uziel, Rehovot (IL); Edith Ronen, Ramat-Hasharon (IL); Shehab Hajyhia, Taybe (IL); Adi Regev, Hod Hasharon (IL)

(72) Inventors: Roie Uziel, Rehovot (IL); Edith Ronen, Ramat-Hasharon (IL); Shehab Hajyhia, Taybe (IL); Adi Regev, Hod Hasharon (IL)

(73) Assignee: Hewlett-Packard Development Company, L.P., Houston, TX (US)

(21) Appl. No.: 14/001,782

(22) PCT Filed: Mar. 9, 2011
(86) PCT No.: PCT/US2011/027648

§ 371 Date: Aug. 27, 2013

(51) Int. Cl. G06F 21/00

(52) U.S. Cl. CPC G06F 21/00
USPC 726/1

(57) ABSTRACT

A request to change a component of an infrastructure is received (102). In response to the request a change process having plural phases is performed (104). A transition between plural phases is allowed based on at least one policy.

### BACKGROUND

An information technology (IT) infrastructure of an enterprise (e.g., a company, an educational organization, a government agency, etc.) can include a relatively large arrangement of electronic devices, software components, and database components. Often, changes are made to components in the infrastructure, which can be complex to manage.

### BRIEF DESCRIPTION OF THE DRAWINGS

Some embodiments are described with respect to the following figures:

FIG. 1 is a flow diagram of change process management according to some implementations:

FIG. 2 is a block diagram incorporating some implementations; and

FIG. 3 is a flow diagram of a change process management according to alternative implementations.

### DETAILED DESCRIPTION

Changes to an information technology (IT) infrastructure, particularly a relatively large IT infrastructure, can be complex to manage. An IT infrastructure includes hardware components (e.g., computers, storage servers, communications devices, and so forth), software components (e.g., applications, operating systems, drivers, and so forth), database components (e.g., relational database management systems, unstructured database systems, and so forth), and/or other components. In some examples, an IT Infrastructure may even include visualized systems, which include virtual machines. A physical machine can be partitioned into multiple virtual machines, and each virtual machine can appear to be an actual physical machine to a user. More generally, an “IT infrastructure” or “infrastructure” refers to an arrangement of components, such as those noted above.

Often, IT administrators of an enterprise are tasked with implementing changes to an IT infrastructure. Due to the complexity of the IT infrastructure, a manual change process can be time consuming, and can result in errors. Moreover, an IT infrastructure may include automated tools that can request or implement changes, which can lead to increased numbers of changes requested or made in the IT infrastructure. Automated tools are usually unaware of the impact of their changes on various aspects of an enterprise, and in fact, automated toots may even bypass or violate policies of the enterprise.

In accordance with some implementations, policy-based change process management mechanisms or techniques are provided to allow for (largely) automated management of change processes in an IT infrastructure. In some implementations, a workflow engine is provided to implement a change process, where the workflow engine can be associated with other modules for managing the change process. A change process results from a requested change to a part of an infrastructure. In some examples, change processes can be performed in conformance with ITIL (Information Technology Infrastructure Library) guidelines or other types of guidelines. ITIL provides best practices for IT operations.

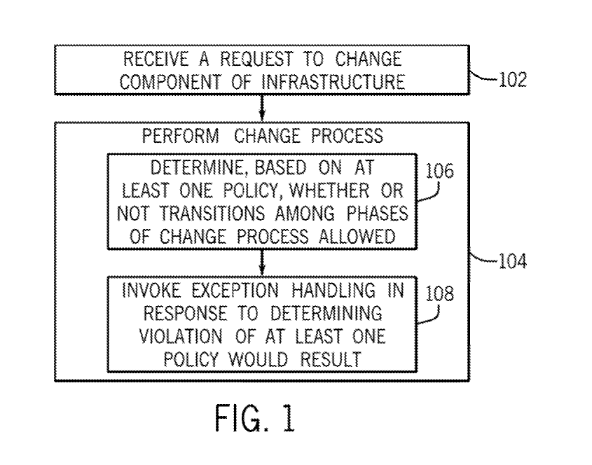

FIG. 1 illustrates change management processing according to some implementations. A workflow engine receives (at 102) a request to change a component in an infrastructure, The component that is the subject of the requested change can he a hardware component, a software component, firmware component, database component, and/or other type of component, or some combination of components. In response to the request, the workflow engine performs (at 104) a change process having multiple phases. The multiple phases of a change process correspond to respective multiple tasks that are to be performed to effect a requested change. For example, the multiple phases can include an initialization phase (to begin the process of effecting the change), an authorization phase (to determine whether the requestor is authorized to make the change), an implementation phase (to implement the change), and a closure phase (to close out the change process). In some examples, the phases of a change process can he according to ITIL guidelines; techniques or mechanisms according to some implementations are thus able to comply with the ITIL standard.

The change process (104) includes determining (at 106), based on accessing at least one policy, whether or not transitions among the multiple phases are allowed. The determining of whether transitions among the multiple phases are allowed includes invoking a policy rule engine to apply the at least one policy for each transition between successive ones of the phases.

The change process (104) further includes invoking (at 108) exception handling by the policy rule engine in response to determining that violation of the at least one policy would result from a particular one of the transitions. In some implementations, if there are multiple violations of respective policies, then exception handling (108) can he invoked for each of the policy violations.

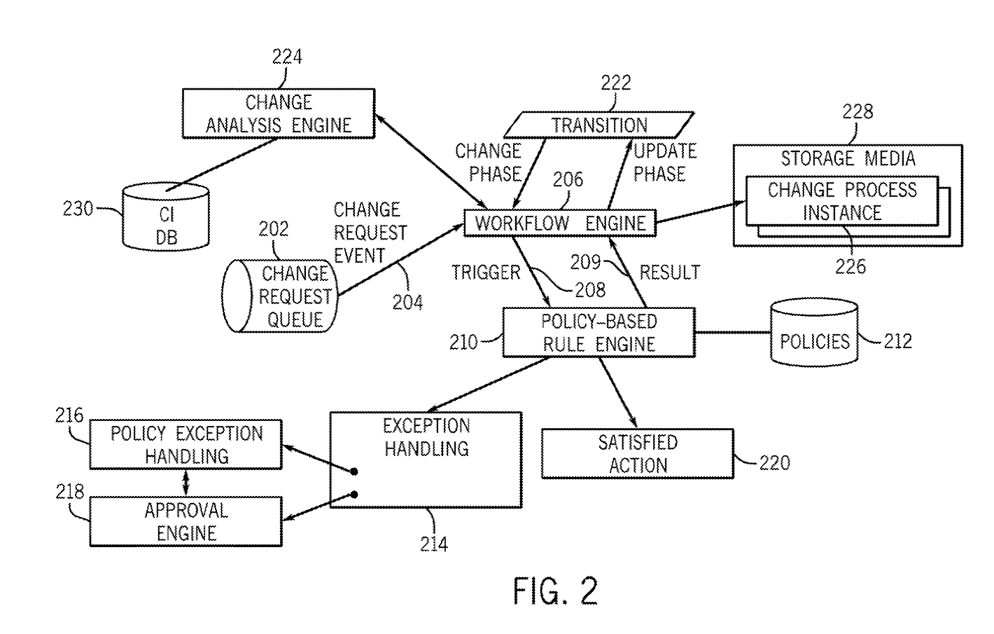

FIG. 2 is a block diagram of an example system including an arrangement of modules involved in performing change process management. A change request queue 202 is provided for storing requests for change that have been received by the system. The change requests in the queue 202 can be submitted by users (such as IT administrators) and/or by automated tools in the system. Each change request in the queue 202 is provided as a change request event (204) to a workflow engine 206. For each transition from a current phase to a next phase, the workflow engine 206 triggers (at 208) a policy-based rule engine 210 to determine, based on at least one respective policy, whether or not the transition between the current phase and the next phase would result in violation of the at least one policy. To the extent that there are multiple policy violations, the workflow engine 208 would trigger (at 208) the policy-based rule engine 210 multiple times to handle the multiple policy violations, before transition between the current phase and the next phase is allowed.

Generally, the workflow engine 206 is responsible for managing and executing the change process in response to a change request. The workflow engine steps through the various phases of the change process, starting from an initial phase, through any intermediate phases, and finally to a change closure phase. The workflow engine 208 ensures that an entire transaction of each change process will all occur or none will occur—in other words, every action or transition of the change process will all occur or none will occur. When the workflow engine 206 starts a change process in response to a change request, an instance 226 of the change process is created uniquely for this change request. The instance 228 of the change process is stored in persistent storage media (228) so that the change process instance can persist even after system shutdown or reset. Upon system reset, the persistent change process instance 226 can continue from the last phase.

As depicted in FIG. 2, multiple change process instances 226 (corresponding to respective change requests) can be stored in the storage media 228, which can ho implemented with disk-based storage media, integrated circuit storage media, or other type of storage media.

The policy-based rule engine 210 is able to access policies stored in a policy database 212. A policy is generally a guideline to the change process for indicating terms and conditions for transitioning the change process between successive phases. The policy has an association condition for determining whether or not to apply the policy for a given change process (or change processes). The policy can also identify a policy owner that is to be notified in case a requested change violates the policy. A policy owner can be a human or an automated tool, such as a management application. The policy can also be associated with information to indicate to which of the phases of a change process the policy is to be applied. Such information can be expressed as a type of the policy, where the type would provide the indication of which change process phase(s) the policy is to be applied to. Alternatively, other information associated with a policy can provide the indication of which phase(s) of the change process the policy is to be applied to.

The policy can also be associated with further information that indicates actions to take with the requested change in case of violation of the policy.

Rules of the policy can be represented in expression language that provides a true or false result for a requested transition between phases of a change. process. The rules can have various conditions based on change attributes or analysis relating to the impact and risk of a particular change process.

If the policy-based rule engine 210 determines that no violation of a policy would occur for a current transition between phases of the changs process, then the policy-based rule engine implements the satisfied action 220, which is an action performed in response to a determination that the transition between the particular pair of successive phases of the change process is allowed. The satisfied action 220 can include an indication provided back to the workflow engine 206 (in result 209) that the transition between the particular phases of the change process is allowed. Additionally, it may be possible for the policy-based rule engine 210 to modify the change request as part of the exception handling 214 or the satisfied action 220. The updated change request can be provided to the change request queue 202 for further processing by the workflow engine 200.

If the policy-based rule engine 210 determines that violation of a policy would occur for a current transition between phases of the change process, then exception handling 214 is performed. Exception handling can involve invoking a policy exception engine 216, which determines how to handle the violation of the policy. The exception tending depends on the current phase of the change process, the type of policy breached, and the configuration of the policy. The policy exception engine 216 checks to ensure that all exception terms are satisfied before allowing the change process to move to the next phase. Exception terms can include, for example, notification of a policy owner, approving the violation by at least one stakeholder, or some other term.

If approval of a violation is sought prior to allowing the change process to proceed to the next phase, the policy exception engine 216 can invoke an approval engine 218, as part of the exception handling 214. The approval engine 218 can send notification containing information of the violation to one or multiple stakeholders (which can be humans and/or automated tools). In response to the notification of the violation, the at least one stakeholder can respond with approval or dis-approval of the violation. In the case of multiple stakeholders, approval can be based on a predefined combination of positive indications received from the multiple stakeholders approving of the violation. For example, the predefined combination of stakeholders can be a majority of the stakeholders. Alternatively, the predefined combination can be (1) any of the multiple stakeholders, (2) all of the multiple stakeholders, or (3) a majority of a quorum of the multiple stakeholders.

If approval is received from the at least one stakeholder regarding the violation, that indication is provided from the approval engine 218 back to the policy-based rule engine 210. which can implement the satisfied action 220. In case approval from any particular one of multiple stakeholders is no longer relevant (for instance, the majority of stakeholders have already rejected the violation or the majority has already approved), the remaining stakeholder(s) (who have not yet provided their approval or disapproval) can be notified that the remaining stakeholder(s) no longer have to provide their approval.

As further depicted in FIG. 2 assuming that a transition between a current pair of successive phases of the change process is allowed (based on the determination made by the policy-based rule engine 210), the workflow engine 206 updates the phase of the change process by transitioning (322) to the next phase, which is further processed by the workflow engine 208 by repeating the various tasks discussed above. Thus, the workflow engine 208 iterates through successive phases of the change process, invoking the policy-based rule engine 210 for each transition.

FIG. 2 further depicts a change analysis engine 224, which assesses a potential risk and impact of a particular change requested by a change request in the queue 202. A component that is the subject of a change can be represented by a configuration item (CI). A CI defines a configuration of an electronic device, a software component, a database component or any other component of an IT infrastructure. A “configuration” can include an attribute associated with the component. Generally, a configuration item represents a discrete unit of a configuration relating to a component. A configuration item can be related to another configuration item (or multiple other configuration items).

Correlation information can be provided to specify relationships between CI(s). The change analysis engine 224 is able to access the CI that is the subject of the change request, along with any other CI that is related to the CI that is the subject of the change request. The assessment by the change analysis engine 224 identifies the CI(s) that would be affected by the change request, the probability of the impact, and/or the severity of the impact. For example, attribute(s) of a change request can indicate the component(s) of an IT infrastructure requested to be changed. For example, such a component change can include installing a program patch on a server. The CI for the server can indicate what other component(s) (associated with other CIs) would be affected if the server were to go down to install the program patch. Such other component(s) can include application(s), user(s), other server(s), and so forth. CIs can be stored in a database 226.

The change analysis engine 224 can produce a data structure that identifies CI(s) to be affected by the change request. The data structure can be in the form of an impact graph (or other structure), for example, which depicts links between the requested change and the respective CI(s). Risk calculation determines the probability of failure and potential damage, which can be based on a predefined risk function that considers various factors. The factors can include the specific CI(s) impacted, relationship of the specific CI(s) to other CI(s), the severity level and the probability of the impact, and other configurable parameters relating to the requested change. The result of the risk calculation is a measurable score level to distinguish between low risk, medium risk, or high risk. For example, in particular server going down to perform installation of a program update can cause a critical application to go down during certain time periods, which would be considered a high risk policy violation.

In some implementations, exception handling (214) may be implemented for change process transitions that are considered to be high risk, with exceptional handling not triggered for change transitions that are low or medium risk. Thus, in such implementations, a policy-based rule engine 210 would not invoke exception handling 214 for change process transitions that may violate a policy, but where the risk is considered low or medium. By invoking exception handling for just change process transitions that are considered to be high risk, the amount of exception handling performed by the system can be reduced, thereby reducing the overall load on the system in processing change requests. More generally, exception handling can be invoked for change process transitions that are associated with scores that exceed a particular threshold; exception handling is not invoked for change process transitions that do not exceed the particular threshold. A score “exceeding” a threshold refers to the score being greater or less than the threshold, depending on the implementation.

By employing the change process management according to some implementations, change process times can be reduced and be made more reliable. Human intervention can be reduced such that human errors resulting from such human intervention can be reduced. Also, by reducing human intervention, workforce efforts for managing change processes can he reduced, which can result in reduced workforce costs and improved change process throughput.

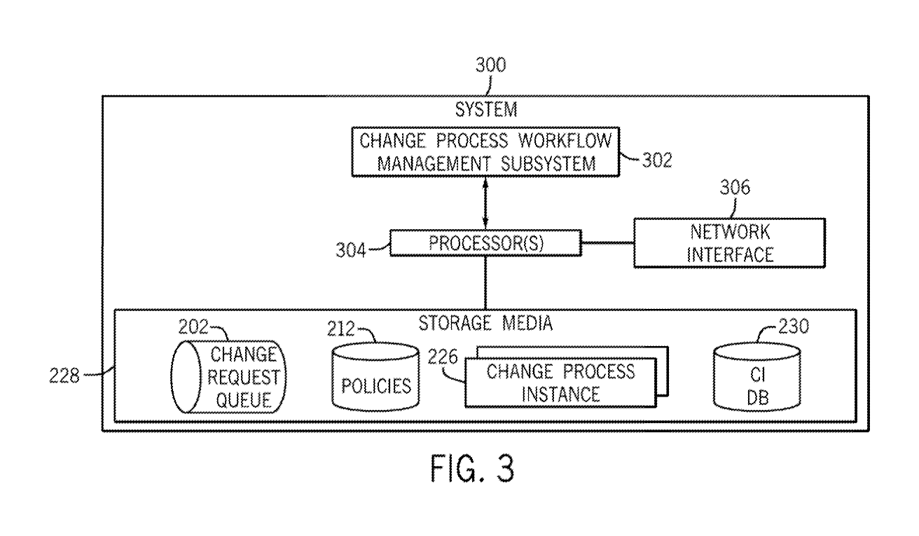

Mechanisms or techniques according to some implementations can be implemented in a system such as a system 300 depicted in FIG. 3. The system 300 includes a change process workflow management subsystem 302, which can include some or all of the modules depicted in FIG. 2. The modules of the change process workflow management subsystem 302 can be executable on one or multiple processors 304 in the system 300. The processor(s) 304 is (are) connected to storage media 228. The processor(s) 304 can also be connected to a network interface 306 to allow the system 300 to communicate over a data network with a remote system, such as a client system to allow for submission of change requests. The client system can allow a user to submit a change request, or the client system can run an automated tool that can submit change requests. The system 300 can be connected over the data network to multiple client systems.

Machine-readable instructions of various modules described above (Including 206, 210, 218, 218, and 224 of FIG. 2, for example) are loaded for execution on the processor(s) 304. A processor can include a microprocessor, microcontroller, processor module or subsystem, programmable integrated circuit, programmable gate array, or another control or computing device.

Data and instructions are stored in respective storage devices, which are implemented as one or more computer-readable or machine-readable storage media. The storage media include different forms of memory including semiconductor memory devices such as dynamic or static random access memories (DRAMs or SRAMs), erasable and programmable read-only memories (EPROMs), electrically erasable and programmable read-only memories (EEPROMs) and flash memories; magnetic disks such as fixed, floppy and removable disks; other magnetic media including tape; optical media such as compact disks (CDs) or digital video disks (DVDs); or other types of storage devices. Note that the instructions discussed above can be provided on one computer-readable or machine-readable storage medium, or alternatively, can be provided on multiple computer-readable or machine-readable storage media distributed in a large system having possibly plural nodes. Such computer-readable or machine-readable storage medium or media is (are) considered to be part of an article (or article of manufacture). An article or article of manufacture can refer to any manufactured single component or multiple components. The storage medium or media can be located either in the machine running the machine-readable instructions, or located at a remote site from which machine-readable instructions can be downloaded over a network for execution.

In the foregoing description, numerous details are set forth to provide an understanding of the subject disclosed herein. However, implementations may be practiced without some or all of these details. Other implementations may include modifications and variations from the details discussed above. It is intended that the appended claims cover such modifications and variations.

1. A method comprising:
receiving, by a system having a processor, a request to change a component in an infrastructure;
in response to the request, performing, by the system, a change process having plural phases, wherein the change process comprises:
determining, based on accessing at least one policy, whether or not transitions among the plural phases are allowed, wherein the determining comprises triggering a policy rule engine to apply the at least one policy for a particular transition between successive ones of the plural phases; and
invoking exception handling by the policy rule engine in response to determining that violation of the at least one policy would result from the particular transition.

2. The method of claim 1, wherein information associated with the at least one policy indicates selected ones of the phases to which the at least one policy is to be applied, and
wherein, triggering the policy rule engine for the particular transition is in response to

3. The method of claim 1, wherein information associated with the at least one policy identifies one or multiple change processes to which the at least one policy is to be applied, and wherein the policy rule engine is to apply the at least one policy to the change process corresponding to the request based on the information.

4. The method of claim 1, wherein the at least one policy identifies an entity that is to be notified in case of violation of the policy, and
wherein invoking the exception handling comprises notifying the entity of the violation.

5. The method of claim 1, wherein invoking the exception handling comprises:
providing information of the violation to at least one stakeholder to prompt for approval or dis-approval of the particular transition.

6. The method of claim 5, further comprising:
in response to receiving approval of the particular transition from the at least one stakeholder, allowing the change process to perform the particular transition to a next phase of the change process, and continuing with the change process.

7. The method of claim 5, wherein providing the information of the violation to the at least one stakeholder comprises providing the information of the violation to plural stakeholders,
wherein approval of the particular transition is based on a predefined, combination of positive indications from the plural stakeholders to allow the particular transition.

8. The method of claim 1, wherein the change process further comprises:
assessing a risk of the change requested by the received request, wherein assessing the risk is based on the component being changed and based on a relationship of the component to at least another component in the system.

9. The method of claim 8, wherein the component being changed and the another component are represented by respective configuration items, and wherein the relationship between the configuration items are expressed by a correlation between the configuration items.

10. The method of claim 8, wherein invoking the exception handling is invoked based on the assessed risk exceeding a predefined threshold.

11. (canceled)

12. A system comprising:
at least one processor; and
a management subsystem having at least one module executable on the at least one processor to:
receive a change request for changing a component of an infrastructure;
perform a change process in response to the change request, the change process having plural phases;
decide to transition between successive ones of the plural phases based on whether or not a respective transition between successive ones of the plural phases would violate at least one policy, as determined by a policy rule engine;
allow a given transition between successive ones of the plural phases if the at least one policy would not be violated; and
invoke exception handling for the given transition if the at least one policy would be violated

13. The system of claim 12, wherein the exception handling comprises providing notification of violation of the at least one policy to plural stakeholders, and wherein a decision to decide whether the given transition is allowed is based on receiving approval from a predefined combination of the plural stakeholders.

14. The system of claim 13, wherein the predefined combination of plural stakeholders comprises one of; (1) a majority of the plural stakeholders; (2) any of the plural stakeholders; and (3) a majority of a quorum of the plural stakeholders.

15. The system of claim 12, further comprising a change request queue to store the received change request, wherein the change request queue further stores additional change requests to he processed by the management subsystem, and wherein the management subsystem is to further;
as part, of performing the change process, modify the received change request; and store the modified change request in the change request queue for further processing.

16. An article comprising at least one machine-readable storage medium storing instructions that upon execution cause a system having a processor to perform a method comprising;
receiving, by a system having a processor, a request to change a component in an infrastructure;
in response to the request, performing, by the system, a change process having plural phases, wherein the change process comprises;
determining, based on accessing at least one policy, whether or not transitions among the plural phases are allowed, wherein the determining comprises triggering a policy rule engine to apply the at least one policy for a particular transition between successive ones of the plural phases; and
invoking (108) exception handling by the policy rule engine in response to determining that violation, of the at least one policy would result from the particular transition

17. The article of claim 16, wherein information associated with the at least one policy indicates selected ones of the phases to which the at least one policy is to be applied, and
wherein triggering the policy rule engine for the particular transition is in response to the information.

18. The article of claim 16, wherein information associated with the at least one policy identifies one or multiple change processes to which the at least one policy is to be applied, and wherein the policy rule engine is to apply the at least one policy to the change process corresponding to the request based on the information.

19. The article of claim 16, wherein the at least one policy identifies an entity that is to be notified in case of violation of the policy; and
wherein invoking the exception handling comprises notifying the entity of the violation.

20. The article of claim 16, wherein invoking the exception handling comprises:
providing information of the violation to at least one stakeholder to prompt for approval or dis-approval of the particular transition.

21. The article of claim 16, wherein the method comprises:
assessing a risk of the change requested by the received request, wherein assessing the risk is based on the component being changed and based on a. relationship of the component to at least another component in the system.
